(19) United States
(12) Patent Application Publication
(10) Pub. No.: US 2004/0022918 A1
(43) Pub. Date: Feb. 5, 2004

(54) Dairy product

(76) Inventors: Anthony J. McCarthy, Kells (IE); Elizabeth Cecilia McDonough, Kilkenny (IE); John Anthony O'Connor, Kilkenny (IE)

Correspondence Address: JACOBSON HOLMAN PLLC, 400 SEVENTH STREET N.W., SUITE 600, WASHINGTON, DC, 20004, US

(21) Appl. No.: 10/407,432

(22) Filed: Apr. 7, 2003

(30) Foreign Application Priority Data
Oct. 10, 2000 (EP) 00650145.6

(51) Int. Cl. A23C 1/00

(52) U.S. Cl. 426/580

(57) ABSTRACT

A diary product contains dairy proteins, the product being at least semi-solid and containing greater than 0.15% by weight of casein macropeptide (CMP). The mass ratio of CMP to whey protein is 1:4.9 or greater. The product may be a natural cheese or a processed cheese. To obtain the desired product, a natural casein isolate protein (NCI) source is combined with a moisture and a fat source and coagulated.

### INTRODUCTION

The invention relates to a dairy product.

Manufacture of cheese from milk is traditionally accomplished by coagulating milk using rennet enzyme. The coagulum has the tendency to contract into a curd as it expresses whey. The removal of whey from the curd is then effected. The curd may be further processed in different ways to become the final cheese. Casein macropeptide (CMP) is cleaved from the casein protein as a result of the action of the rennet on kappa casein and about 90% of this CMP is typically removed with the whey. Thus traditional cheese is an excellent source of nutrition, rich in minerals and protein while being low in whey proteins but also low in CMP.

CMP is known to be therapeutically beneficial. A number of researchers have reported that CMP has significant bioactivity in regulating the digestive system (Stan et al. (1983) Fiziol Zh SSSR 69, 855-859). Research (Otani et al Milchwissenschaft 47 (8) 1992) has also shown that CMP was able to inhibit mitogenesis and that this could modulate the immune system to help prevent atopic reactions to food antigens. CMP was also found to have Bifidogenic (probiotic) properties (Azuma et al (1984) Agric. Biol. Chem., 48 (8), 2159-2164). Additionally CMP has been found to be effective against the cholera toxin (Kawasaki et al., (1992) Biosci. Biotech. Biochem., 56, 195-198) and has demonstrated inhibition of all strains of influenza virus (Kawasaki et al. (1993) Biosci. Biotech. Biochem., 57, 1214-1215). The characteristics and potential uses of CMP are reviewed by Abd El-Salam et al. (1996) in the Int. Dairy Journal 6, 327-341.

CMP is a heterogeneous group of proteins. CMP contains all the genetic variations and post-translational modifications of kappa casein (Yvon et al Reprod Nutr Dev (1994) 34, 527-537). As a result of this CMP may have two amino acid sequence (variants type A and B), differing degrees of phosphorylation and most significantly a range in the level, position and type of carbohydrate moieties. The predominant carbohydrate is sialic acid. Kappa casein is a rich source of the amino acid threonine with 14 to 15 threonine residues depending on the genetic variant. However about 80% of the total threonine in kappa casein resides in the CMP portion. CMP has a molecular weight of about 7,000 KDa and as such may be considered to be more like a small protein. Due to the degree of glycosylation, CMP occupies a much larger hydrodynamic volume than its molecular weight would indicate and therefore is retained by ultrafiltration membranes. Casein macropeptide is variously referred to as casein macropeptide, caseinomacropeptide, casein-derived peptide, casein glycopeptide and sometimes, erroneously as glycomacropeptide. CMP has varying levels of carbohydrate moieties. A small fraction of CMP however, may have very low or no carbohydrate moiety and therefore is not technically a glycomacropeptide. Glycomacropeptide or GMP however is the principal (50 to 75%) component of CMP. The carbohydrate content of the GMP renders it soluble in a 12% trichloroacetic acid solution. A number of the analytical measurement techniques have a pre-treatment, which involves a TCA solution, this may remove at least a portion of die non-glycosylated CMP. For example the method published in The Official Journal of the European Communities (L228/10 Annex IV). This details a HPLC method for measuring GMP in dairy products and uses the GMP level to calculate the level of cheese whey present in a sample. For any specified GMP content it can be assumed that the corresponding CMP level is 1.33 to 2 times greater. The heterogeneity of CMP makes it difficult to measure. However there are a number of suitable methodologies for example that of Léonil et al (Journal of Dairy Research (1991), 58, 321-328) which relies on ion exchange chromatography and eliminates the need for a TCA treatment and therefore measures the CMP rather than just the GMP. Indirect techniques to determine the level of CMP in a cheese would include measuring the level of sialic acid or Threonine levels.

In comparison to CMP whey proteins, particularly beta lactoglobulin (BLg) and alpha lactalbumin (ALA) are known milk allergens (Internet Symposium on Food Allergens 2(1):9-74 (2000) http:/www.food-allergens.de). The presence of whey proteins in cheese also have an adverse effect on functionality, particularly in mozzarella cheese.

Faquant et al. Technique Laitiere & Marketing 1988 No. 1028, 21-23 describes the separation of whey proteins from casein proteins utilising microfiltration.

EP-A-0 542 583 describes a process using microfiltration to remove soluble whey or serum proteins and subsequently subjecting the deserumproteinised material to a heat treatment to make a dairy material which is said to be suitable for transformation into cheese. The process involves the removal of about 80% of the cheese milk volume in a whey separation step so that 80% of the CMP is also removed. This results in at most a doubling of the CMP present in the finished cheese compared to traditional cheese, however a processor would still incur the cost of processing /disposing the retained whey.

PCT/NZ95/00086 describes a process for making a whey protein depleted milk protein concentrate (wpdMPC) and the use of the wpdMPC product in the manufacture of dairy products.

U.S. Pat. No. 5,378,478 describes ultrafiltration and evaporation of skim milk to make a milk protein concentrate for cheese manufacture. The CMP component and all of the whey proteins are retained.

EP-A-0 435 573 describes a process for making a skim cheese utilising a Dorr-Oliver ultrafiltration retentate. The resultant product retains all of the CMP and all of the whey proteins normally present in milk.

Another approach has been to remove or isolate the whey proteins or CMP from a raw milk product. The whey proteins or CMP are then re-introduced to a final product. Such processes, however, involve additional processing steps and significant levels of whey protein are still present.

WO-A-00 49885 describes the use of a milk protein hydrolysate for addressing bone or dental disorders. Casein glycomacropeptide (CGMP) is extracted from sweet whey by a combination of electrodialysis, cation exchange resin, anion exchange resin, evaporation, spray drying, ultrafiltration and freeze drying. The CGMP is used to enrich foods or liquid enteral compositions with CMP. The fermented and gelled milk products are enriched in CMP but the level of whey protein also remains high.

WO-A-94/15952 describes a method of producing kappa casein glycomacropeptide or CMP. CMP is removed from casein via rennet whey as a first step. The lactose and some of the minerals are then removed from the whey by ultrafiltration to produce a whey protein concentrate (WPC). The major whey proteins are then removed from the WPC by a process of thermal denaturation and precipitation of the protein to leave the CMP and some non-protein nitrogen in solution. This supernatant is then further concentrated by hyperfiltration and spray drying, before being incorporated into a protein free food product.

U.S. Pat. No. 4,919,943 describes a process to remove whey proteins however the whey protein is then re-introduced to the final product. While this provides a solution to the functionality problem associated with whey proteins the whey proteins are still present in the final product and pose a potential allergy problem. Processing costs are also increased.

There is therefore a need for a dairy product containing dairy proteins that is rich in CMP with reduced allergenicity and enhanced functionality. There is also a need for a process for producing such a product on an economic factory scale.

### STATEMENTS OF INVENTION

According to the invention there is provided a dairy product containing dairy proteins, the product being at least semi-solid and containing greater than 0.15% by weight of casein macropeptide (CMP) and a mass ratio of CMP to whey protein being greater than 1:4.9. For clarity, in this specification for example a ratio of 1:2 is greater than a ratio of 1:4, therefore a greater ratio requires lower whey protein levels.

In this specification, “at least semi-solid” refers in particular to any cheese which offers greater than 450 g of peak force of resistance to deformation as measured as follows.

Firstly the cheese is cut into 16 mm cubes covered with cling film, and tempered in a 5° C. incubator for 2 hours. Using the Stable Micro Systems TA.XT2i texture analyser, on TPA mode with the following settings:

| | | |
|---|---|---|
| Pre-test speed: | 0.4 | mm/s |
| Test speed: | 0.4 | mm/s |
| Post-test speed: | 0.4 | mm/s |
| Distance: | 11.2 | mm (70% compression) |
| Trigger type: | auto - 20 | g |
| Time: | 5 | secs |
| Data acquisition rate: | 50 | pps |

Probe Type: 35 mm Cylinder with 5 Kg Load Cell

Test Set-up: The sample is positioned centrally under the cylinder and the test commenced. The peak force is then determined by selecting the highest force reading recorded during the entire test.

For many food applications it is advantageous to have a solid or semi-solid food such as in sandwich and pizza applications. It is very difficult to slice or shred cheese with a peak force resistance of less than 450 g. Generally however, the cheese needs to be firmer than this for slicing and shredding. The cheese of the present invention may be made to a wide range of final textures.

The invention also provides an at least semi-solid dairy product containing greater than 0.15% by weight of casein macro-peptide (CMP), the product having a high CMP to whey protein ratio and the product has a total solids content as measured by the method based on I.D.F. 4:1985 of at least 50% by weight.

In another aspect the invention provides an at least semi-solid dairy product containing greater than 0.15% by weight of casein macropeptide (CMP), and the product has a total solids content as measured by the method based on I.D.F. 4: 1985 of at least 42% by weight.

In another aspect the invention provides an at least semi-solid dairy product containing greater than 0.15% by weight of casein macropeptide (CMP) and the product, on manufacture, has a sodium chloride content of at least 1.0%, preferably 1.5% as determined by B.S. 770 1963. In the context of this specification, the term “on manufacture” means that the salt can be incorporated into the liquid mix, in effect directly into the cheese milk, since no whey need be removed and consequently the salt remains with the product. Thus the salt is present in the correct proportions at the point the liquid mix becomes a cheese, that is at the point of rennet coagulation. Thus the necessity for subsequent processing of the cheese such as milling the cheese and then salting it or immersing the cheese in a brine solution or rubbing dry salt to the surface of the cheese is eliminated.

In a further aspect the invention provides an at least semi-solid dairy product containing greater than 0.15% by weight of casein macropeptide (CMP), and contains a biologically functional additive. Preferably the biologically functional additive is present in an amount of at least sufficient to produce a desired biological effect in the consumer. The precise amount required varies considerably depending on the nature of the additive and the quantity of cheese consumed. While not wishing to be proscriptive the amount that the product of the current invention can carry can be as high as 25% by weight of the finished product and greater, depending on the nature of the additive.

In a preferred embodiment of the invention the product contains a CMP to whey protein mass ratio of greater than 1:4.5, preferably greater than 1:4.0, most preferably greater than 1:3.5, ideally greater than 1:3. As the level of whey protein is reduced the allergenicity of the finished product is reduced for those individuals that have an allergic reaction to the ALA and BLg whey proteins. Furthermore the functional properties of the cheese such as texture, flavour, melt and stretch are improved with lower levels of whey protein. As the Ala and BLg proteins are allergens and the CMP helps to reduce allergenic response it is particularly beneficial to have a high ratio of CMP to whey protein.

In one embodiment the product contains greater than 0.25%, preferably greater than 0.35% by weight of CMP, preferably greater than 0.45% by weight of CMP, more preferably greater than 0.55%, most preferably greater than 0.75% by weight of CMP.

In a particularly preferred embodiment the CMP levels are in excess of 0.85% by weight, most preferably 0.95% by weight, of the cheese.

The advantage of increasing levels of CMP are accomplished by removing less and less whey, until ultimately no whey is removed at all. Because there are lower levels of whey to process processing costs are reduced and ultimately eliminated. The resultant cheese will be more beneficial to the consumer with increasing levels of CMP in view of the bioactive properties of CMP whilst being substantially free of whey protein.

Other benefits of an essentially whey-less cheese make are that salt added during the process is not lost in the whey so the need for mill salting, brine salting or dry salting is eliminated. Furthermore, water soluble nutrients and ingredients with physical and biological functionality such as certain vitamins, prebiotics like fructooligosaccharides can be incorporated into the cheese without contaminating or being lost to the whey.

The process also allows for the incorporation of insoluble ingredients like fibre, lipids and oil soluble ingredients with health promoting properties or for other technical or commercial benefits. In traditional cheese manufacture the whey separation process results in some of these ingredients being lost to the whey.

The product of the invention contains less than 2.5% by weight of whey protein, preferably less than 1.75%, most preferably less than 1.4%, ideally less than 1.25%.

The product may be a process cheese product or a natural cheese product. The process cheese product includes emulsifying salts while the natural cheese product is free of such salts.

A further aspect the invention provides a method to manufacture an at least semi-solid product which comprises:

(i) combining with the aid of mixing and heating as necessary:

a) an amount of natural casein isolate (NCI) protein source such that 7% to 85% of the product by weight is NCI protein;

b) an amount of a moisture source such that 10% to 85% of the product by weight is moisture;

c) an amount of a fat source such that 0.1% to 60% of the product by weight is fat;

d) a food grade acid, either added externally or generated internally through the action of microbial fermentation to reduce the pH to about 6.5 to 5.0

(ii) subjecting the mixture thus formed to the action of a coagulant such as rennet enzyme in sufficient concentration and with sufficient time and temperature to convert the product to a semi-solid product at room temperature or below.

This provides a semi-solid product with the benefits of high levels of CMP and low levels suitable for consumption.

In this specification, the term NCI or natural caseinate refers to the product produced by removing the serum proteins from whole casein. Whole casein refers to casein, which has not been enzymatically hydrolysed to paracasein. However any whole casein can be used to produce the product of the invention. This specification describes in detail the ideal source of whole casein, NCI. However this description should not be seen as restrictive. Other suitable sources of whole casein would include caseinate, for example calcium caseinate or calcium sodium caseinate. A person skilled in the art will immediately recognise how these products, combined with various salts can be manipulated to generate a variety of finished product textures and physical functionality.

The process used to produce the at least semi-solid dairy product uses a rennet enzyme to liberate the CMP from the casein and in this way the fluid material is converted into a more amenable solid or semi solid.

Preferably the amount of NCI is such that from 7% to 60% of the product by weight is NCI protein. Most preferably the amount of NCI is such that from 15% to 30% of the product by weight is NCI protein. While the product may be consumed in a dry or semi-dry state as it would be with a NCI protein content of 85%, a more useful product is obtained at lower levels of protein. The higher levels of protein result in a harder product that may be difficult to consume. When proteins are present in the lower range, particularly in the 20% to 25% protein range, semi-solid products are produced that can be easily formed into shapes, sliced, diced and shredded and are easily consumed.

In one embodiment the amount of moisture is such that from 20% to 76% of the product by weight is moisture. Ideally the amount of moisture is such that from 30% to 60% of the product by weight is moisture. Most preferably the amount of moisture is such that from 40% to 55% of the product by weight is moisture.

The lower moisture range provides a product that has improved microbial stability but less desirable sensory properties. At the higher moisture range the product has poorer microbial stability and may be a little too soft to be of wide utility. As the moisture tends towards the intermediate range a very useful product results with good microbial stability, improved sensory characteristics and yet still retaining the benefits of low whey protein and high CMP.

In a further embodiment the amount of fat is such that from 0.1% to 50% of the product by weight is fat. Ideally the amount of fat is such that from 5% to 40% of the product by weight is fat. Most preferably the amount of fat is such that from 10% to 35% of the product by weight is fat.

At the lower fat levels the resultant product may have poor sensory characteristics, while at the higher end of the range the resultant products become nutritionally inferior as fat displaces the more nutritionally useful minerals and proteins.

Preferably the renneting temperatures are in the range of 30 to 65° C. Most preferably the renneting temperatures is approximately 50° C. This higher temperature allows the use of higher solids in the mixing stage.

In one aspect the mixture is converted to a semi-solid product by:

pasteurising the mixture;

cooling the pasteurised mixture; and

inoculating or acidifying the mixture before or after subjecting the mixture to the action of a rennet enzyme.

In another aspect the mixture is converted to a semi-solid product by:

subjecting the mixture to the action of a rennet enzyme before or after acidification; and

pasteurising, packaging and cooling the product thus formed.

Acidification may be carried out by direct acidification with a food grade acid such as lactic acid, citric acid, phosphoric acid for example or by inoculating with an acid producing culture and allowing it to ferment for a period of time.

The advantage of acidifying the product is to improve the flavour, microbial stability of the product and to increase the clotting activity of the enzyme. At the higher end of the pH range the clotting activity is reduced and processing times are increased. In addition the shelf stability is low and the flavour may not be acidic enough. At the lower end of the pH range the shelf stability is good but the stability of the protein to thermal processing is low (if thermal processing is required). Also the flavour may be a little too acidic.

It will be immediately obvious to one skilled in the art that the NCI may be at least partly acidified thus eliminating or reducing the need for acidification during the conversion process described above. This acidification also assists in demineralisation of the NCI to provide for a variety of textures and melt behaviours in the finished cheese.

### BRIEF DESCRIPTION OF THE DRAWINGS

The invention will be more clearly understood from the following description thereof given by way of example only with reference to the accompanying drawings in which:

FIG. 1 is an overview of natural casein isolate (NCI) production including ancillary products; and

FIG. 2 is a schematic block diagram of one of the embodiments of the conversion of NCI into a natural cheese or a process cheese.

### DETAILED DESCRIPTION

The invention provides a method of manufacture of an at least semi-solid dairy product, which has a number of unique and useful advantages over existing technologies. The invention provides a commercially viable semi-solid dairy product wherein the CMP to total whey protein is dramatically altered. The CMP is generated in situ within the food and is retained within it naturally with minimal processing. Furthermore the invention provides a cheese making procedure that does not generate whey.

Whey proteins are a heterogeneous group of proteins and may be measured by a variety of techniques. They are variously referred to as serum protein, albumins and soluble proteins. The typical distribution of major proteins in cheese whey is beta-lactoglobulin at 45%, alpha-lactalbumin at 18%, serum albumin, immunoglobulins and lipoproteins at 5% each, about 2% enzymes and importantly, 15% to 20% CMP (Marshall S. C. Food Res. Quar. 1991, 51, p81).

In this specification whey proteins include the typical proteins of cheese whey. However this specification teaches that the CMP to whey protein ratio can be altered. For the purposes of this specification the term whey protein does not extend to that portion of the CMP that is in excess of that which is normally present. Some of the more basic techniques for estimating whey protein concentration rely on the solubility of this group of proteins and therefore consider nitrogen solubility under defined conditions to be a measure of whey protein concentration. In cheese however, on maturation, the casein proteins may be hydrolysed to release soluble peptides, commonly with a molecular weight below 1000. This increases the soluble nitrogen content, but not the whey proteins as we have defined them and therefore it is not a suitable measure. While there is some debate over the fate of denatured whey proteins during cheese maturation, it is agreed that the undenatured whey proteins alpha lactalbumin and beta lactoglobulin are resistant to hydrolysis during cheese maturation. It is possible therefore to measure these by HPLC. It is common to measure a major protein like beta lactoglobulin and calculate the total whey protein level by comparison with a control, alternatively one might do so by assuming that beta lactoglobulin comprises 45% of the total whey protein. Alternatively, though not usually one might measure the alpha lactalbumin content and calculate the total whey protein by dividing by 0.18. For the purposes of clarity, it would not be appropriate to determine whey protein content by dividing the CMP level by 0.2 since this specification teaches how the normal ratio in whey is altered by the use of the technology herein described. However levels of beta lactoglobulin and alpha lactalbumin may vary slightly with seasonality. A more accurate measure would be to measure the content of beta lactoglobulin (BLg), alpha lactalbumin (Ala) and CMP are determined by chromatography. The minor proteins and enzymes may be calculated as follows:

Minor Proteins=BLg×17/45

The total whey protein content is then calculated as:

Total whey protein=BLg+Ala+CMP+Minor Proteins

An alternative method is to measure the sulphur amino acid content such as methionine and cystine. Whey proteins are a rich source of these amino acids relative to casein and the ratio of sulphur amino acids to total protein might also be used to determine whey protein levels indirectly.

The amount of CMP generated during rennet hydrolysis of casein may vary depending on the conditions used. Kappa casein represents 10% to 15% of the total casein protein. CMP represents 36.84% of the kappa casein. Thus 3.68% to 5.5% CMP (by weight of total casein) can be generated from casein. During cheese manufacture at least 85% of the CMP must be liberated if the milk is to clot (Dagleish D. G. J. Dy. Res. 1979, 46, 653). Thus the lower concentration of 3.13% is possible during cheese manufacture. These figures are consistent with the estimate that CMP comprises 15% to 20% of whey proteins Marshall S. C. Fd. Res. Quart. 1991, 51, 81-91) or a ratio of CMP to whey protein of 1:6.66 to 1:5. As CMP is very soluble it tends to partition similarly to whey proteins which are also very soluble. Consequently cheese would be expected to have a ratio of CMP to whey protein similar to that present in the whey but at a significantly lower overall quantity. In practise these ratios may be significantly higher. Whey proteins are much larger than CMP and therefore are more easily physically trapped by the casein curd. Whey proteins may further aggregate as a result of various processing conditions to greatly increase the rate at which they are retained in the cheese curd. Furthermore, whey protein may complex with casein via thiol—disulphide exchange to be chemically trapped by the casein and retained in the cheese to a greater extent than the CMP. In practise, cheese may have a CMP to whey protein ratio of about 1 to 10.

In this specification the term casein macropeptide or CMP is intended to describe the peptides produced by the action of rennet or any commercial milk coagulant as a result of cleaving kappa casein between amino acid position 105 and 106.

Currently available technology can provide a cheese with low levels of CMP and low CMP:whey protein ratio, for example in traditional cheese, or high levels of CMP and a low CMP:whey protein ratio, for example in cheese from UF milk. However it does not provide for high levels of CMP with a high ratio of CMP:whey protein.

It has been found in the present invention that an at least semi-solid dairy product containing dairy proteins with both a high level of CMP and a high ratio of CMP to whey protein can be prepared.

The present invention provides the cheese maker with an alternative method for making cheese which greatly decreases the capital investment required and produces both finished and by-products with value added properties. Furthermore the present invention offers the possibility of eliminating the need for the cheese maker to have any whey processing equipment. In addition, brining of the cheese or milling or dry salting is not required in the process.

The process of the present invention is beneficial as the CMP is generated in situ within the food and retained within it naturally, with minimal processing.

Importantly the present invention provides cheese with key functional attributes necessary for broad appeal. Specifically the semi-solid product is suitable for shredding and slicing because of its texture and it exhibits stretch characteristics required of pizza topping applications.

Traditional Cheese Making Process

Normal cheese making procedures physically separates the whey from the renneted curd by a variety of processes including cutting, culturing, cooking, washing, cheddaring and pressing. Thus the levels of CMP and whey proteins are quite low ranging from about 0.03% up to 0.10% for CMP and 0.28% to 0.62% for whey protein by wt of the cheese. Of course if the curds are washed both CMP and whey proteins will be further-reduced and to the same extent ie. the ratio of CMP to whey protein remains largely unaffected.

Traditional Cheese Using Ultrafiltration to Pre-Concentrate the Milk.

Cheese made utilising ultrafiltration to concentrate the milk protein prior to coagulation can have CMP levels over 9 times greater than the equivalent cheese made using milk which has not been ultrafiltered. The actual level depends on the concentration factor used during the UF process. As with the traditional make procedure, both CMP and whey protein levels can be reduced to close to zero if the curds are washed with potable water. It is important to note that both the CMP and the whey proteins are increased at best proportionately since generally UF membranes concentrate both CMP and whey proteins to the same extent. So, regardless of these additional steps and regardless of the extent of ultrafiltration pre-treatment the ratio of CMP to whey protein is largely conserved. Thus the CMP: whey protein ratio remains at about 1:5 or less.

Cheese Making Utilising the Technology of this Invention

The invention provides a semi-solid product in which the ratio of CMP to whey protein is greater than 1:4.9, typically in the range of 1:2 to 1:4. The total level of CMP depends on the make procedure but is at least 0.15% (wt/wt) and generally in the range of 0.3% to 1% by weight of the cheese or about 10 times greater than the levels attainable using traditional cheese making methods.

For example, in the preferred embodiment, whey protein is reduced to 5% or less of the NCI protein. This NCI has a protein content of about 85% on a fat free dry basis and is combined with moisture and fat to achieve a final composition of 50% moisture and 25% protein. This results in a cheese with a CMP level of about 0.74 to 1.1% and a ratio of CMP to whey protein of 1:1.7 to 1:1.1.

The process for manufacturing the product of the invention utilises milk as a starting material. In the first stage of a two-stage process, the milk has most of the whey proteins and lactose removed to produce a natural casein isolate (NCI) using known methods. The second stage of the process involves mixing of the NCI with other ingredients and subsequent conversion to cheese without requiring the removal of whey. Throughout the specification unless otherwise specified milk is to be construed as whole milk, cream, skimmed milk, partly skimmed milk, evaporated milk, or any combination of these, which may have been heat treated, fat or protein standardised, pH adjusted, or have some non dairy fat or proteins added.

In the present invention it was found that temperatures in excess of 50° C. could be used for renneting. The temperature for renneting in cheese is normally 30° C., the optimum is 40° C. and the rennet is inactivated at 55° C. (Cheese and Fermented milk Foods by Frank Kosikowski 2^{nd} ed. 1982 p420 to 421). Surprisingly we found that temperatures of up to 65° C. can be used given the speed of reaction under the conditions described. This higher temperature allows the use of higher solids in the mixing stage, specifically total solids in excess of 42%, preferably 50% or greater. Even higher solids may be attained by using a renneting enzyme with higher heat stability. Such enzymes are well known to those skilled in the art and are selected from any one or more of animal, bacterial, fungal or genetically modified sources.

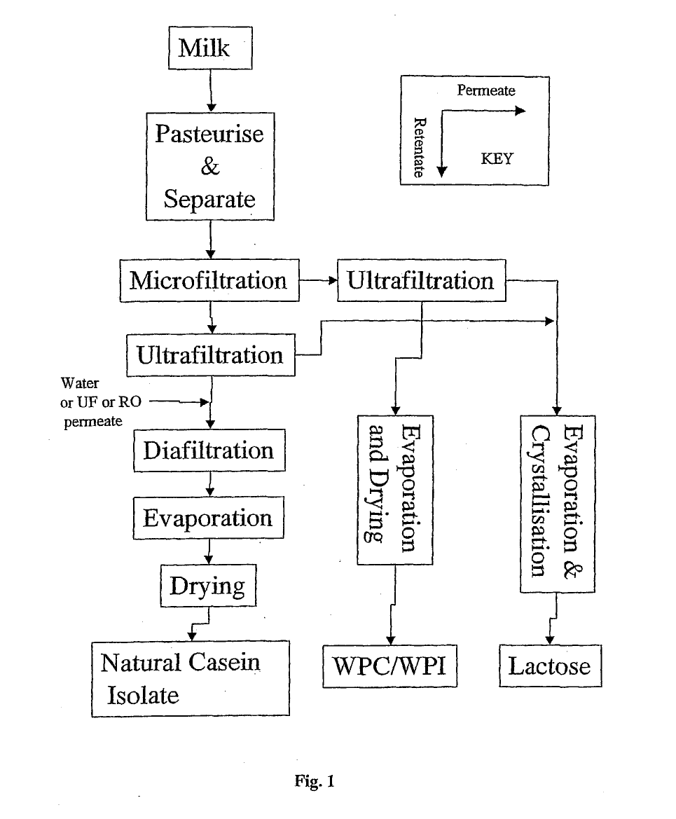

Referring to FIG. 1 the first stage of the process is outlined schematically. The preferred embodiment utilises raw whole milk as the starting material. The raw whole milk is pasteurised, skimmed and subjected to microfiltration to reduce the whey protein content of the retentate to less than 10%, preferably about 5% to 6% of the total protein. The milk may be partially acidified, for example by hydrochloric acid or other suitable food grade acid or by microbial fermentation to the pH range of 6.4 to 5.2 if desired to solublise some of the milk minerals and to facilitate their partial removal from the retentate. This will modify the functional properties of the retentate and the texture, melt and stretch of the resultant cheese. The retentate is subsequently ultrafiltered (UF) to reduce the lactose content to less than 6%, preferably to about 1% to 2% of the total solids. The microfiltration retentate may be coagulated with rennet enzyme prior to ultrafiltration as the UF membrane largely retains the CMP, and while ultrafiltration also largely retains the whey protein, these would have been substantially removed by the previous microfiltration step. However, in the preferred embodiment rennet coagulates at a later stage. Thus, the whey or serum from the process is uncontaminated by the microbes or enzymes normally used during cheese manufacture. Furthermore, the serum is uncontaminated by the by-products of the action of these microbes and enzymes. As a result, the serum of his process has unique flavour and functional properties superior to that of traditional cheese whey. The retentate material of the first stage of this process is known as “Natural Casein Isolate” (NCI) or (Native) Phosphocaseinate (Faquant et al Technique Laitiere & Marketing 1988 no. 1028, 21-23). The NCI is further concentrated by moisture removal and preferably dried to a powder of about 5% moisture, but may be used in a liquid or paste form. The process is described in more detail in example 1

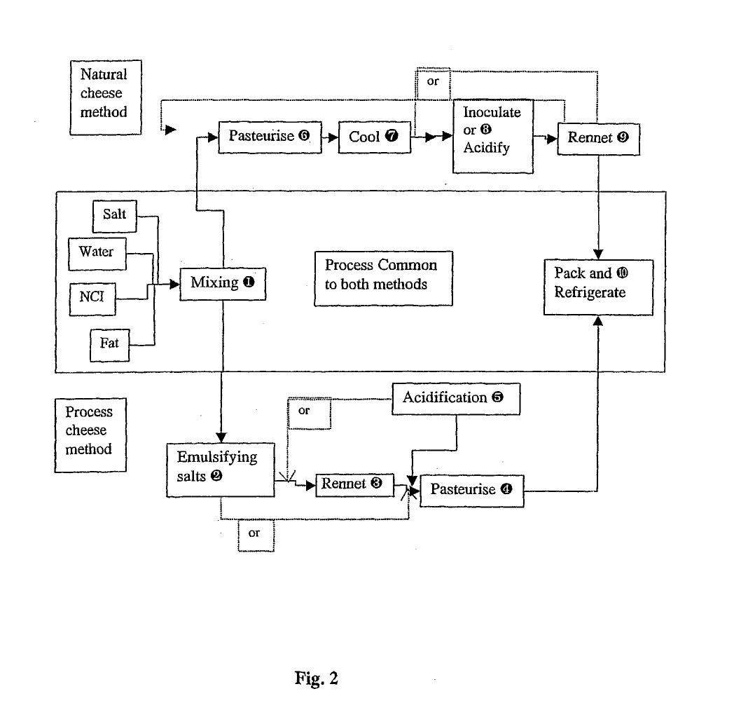

The second stage of the process is outlined schematically in FIG. 2. The NCI from the first stage is converted to a semi-solid dairy product with high levels of CMP and a high ratio of CMP: whey protein, using two methods, a natural cheese method or a process cheese method.

In both methods the NCI is first reconstituted in water to about 20% protein (by weight of the finished product). A fat source such as cream, anhydrous milk fat (AMF), butter oil or vegetable oil is added to achieve about 20% to 25% fat in the finished product. Salt especially sodium chloride is added to taste.

In Step 1 the ingredients, NCI, water, fat and salt are mixed until homogenous and free of lumps. Mixing is carried out with a single or twin screw cooker, ribbon blender or paddle mixer for example a Green Bay Machinery twin screw cooker or a Damrow single screw. The Stephan or Scanema cookers may be used. Also, for higher solids, an extruder such as a twin screw co-rotational extruder such as the type manufactured by Wenger for example may also be used. The mixing is preferably carried out at a temperature of approximately 50° C.

Process Cheese Method

In step 2 emulsifying salts well known to those skilled in the art are added to modify the melt properties or texture of the finished product. These salts also effect shelf life and flavour of the finished product. The emulsifying salts may be selected form any one or more of disodium phosphate, monosodium phosphate, trisodium phosphate, sodium acid pyrophosphate, tetra sodium pyrophosphate, sodium aluminium phosphate, sodium hexa meta phosphate, sodium citrate, di calcium phosphate, EDTA.

In step 3, a Rennet enzyme preparation such as Chymax from Chr. Hansens or other commercially available material is added. Concentration may vary but 0.25 ml per kg of mix is adequate. While a temperature of 50° C. is considered to destroy most commercial rennet enzyme preparations, the concentration of the enzyme and substrate (kappa casein) can be about ten times higher than normal cheese makes. As a result of this the action of the rennet enzyme proceeds at a pace that allows it to hydrolyse the casein sufficiently before it is thermally denatured. Rennet may also be added prior to the addition of the emulsifying salts as shown in FIG. 2.

Step 4 involves any suitable pasteurisation treatment with a time temperature combination of 72° C. for 30 seconds for example. Excessive time temperatures can damage the flavour and texture of the cheese, while inadequate time temperature combinations may pose microbial and other quality problems. This may be accomplished by direct culinary steam injection or by indirect heat. It may be necessary to maintain a low temperature difference between the product and the heating medium (delta-T), or to use a swept or scraped heating surface, or a combination of both, to prevent heat damage to the product.

Step 5 involves acidification to about 6.4 to 5.2 with a suitable food grade acid such as, but not limited to, vinegar, citric acid, lactic acid, phosphoric acid or glucono-delta-lactone (GDL). Preferably the acidification is conducted while mixing vigorously and using a dilute solution at or below 10% total solids (TS) so as to minimise localised pH drop. A pH at or below 6.6 is preferable for swift action of the rennet enzyme. However a pH above 5.0 is desirable to avoid thermal denaturation and coagulation of the protein during the pasteurisation step. While susceptibility to thermal coagulation is dependant on a variety of factors known to one skilled in the art such as concentration of protein, ionic environment, type of pasteurisation equipment and time temperature combination, a pH of about 6.40 to 5.4 generally provides adequate thermal stability and a swift clotting time. The acidification step may be carried out before or after renneting, step 3.

If all the required acidification is not accomplished before step 3 then final pH adjustment may take place at this point. Again the usual food grade acids may be used. Also if gradual pH decline after packaging is desired, glucono delta lactone or indeed starter cultures, particularly thermophillic cultures may be added after pasteurisation. Equally, a relatively static pH can be achieved in the packaged product by a number of means, firstly pasteurisation will tend to eliminate acid producing cultures or by limiting the amount of fermentable substrate.

Natural Cheese Making Process

After mixing the NCI, water, fat and salt in step 1 pasteurisation (step 6) as described for the process cheese method, step 4, is carried out.

In step 7 cooling of the reaction mixture is accomplished by a number of methods known to those skilled in the art such as indirect cooling by addition of ice, infusing CO₂ or indeed quiescent cooling. A temperature high enough to keep the product plastic and suitable for pumping and filling into containers is generally desirable and this depends on the compositional characteristics such as fat level and type, moisture content and pH. Generally a temperature of above 40° C. is adequate. The temperature should be low enough to allow acidification. If a food grade acid is used, the temperature should preferably be below approximately 70° C. to avoid coagulation induced by elevated temperatures and localised low pH. If thermophillic cultures are used a temperature of 52° C. or below is required (depending on the thermal sensitivity of the culture used). In general a temperature of approximately 50° C. is adequate.

In step 8 commercially available dairy cultures and more specifically thermophilic cultures are used to provide the necessary acidification depending on the availability of a fermentable carbohydrate substrate For example a fermentation of an available lactose content of 1 to 2 g per 100 g of finished product by a Chris Hansen DVS thermophilic culture ABT-21, TCC 4 or TCC 21 might be used with to produce a suitable pH drop. The residual lactose in the NCI can provide this or any fermentable carbohydrate can be added. The amount of lactose is not narrowly critical and it depends on the initial pH, desired final pH and the buffering capacity of the product. Generally about 2% lactose is adequate. Those skilled in the art will recognise that more or less lactose can be added limited only by the requirement for certain textural, sensory or shelf life requirements. Cultures may also be used including non-starter lactic acid bacteria for the development of probiotic properties or flavour during storage or exo-polysaccharide producers to alter the texture.

In step 9, the same enzymes as described in step 3 for the process cheese method are used. However the level used will be about a half to a tenth of the levels used in step 3. Much less heat denaturation of the enzyme will occur in the “Natural” method, if it is added after pasteurisation, as compared with the “Process” method and generally high levels of residual rennet enzyme activity is not desirable if bitter flavour development is to be avoided. It is also possible with the natural process to add the rennet enzyme before pasteurisation or during the heating up phase prior to pasteurisation, as described elsewhere temperatures in the range of 50° C. work well.

Process Cheese Method & Natural Cheese Method

Packaging in step 10 is readily accomplished as at this point the product is a plastic mass and is easily pumped and moulded. The product may be cooled to 15° C. to 10° C. and stored for some time if flavour development is desired. Temperatures of below 10° C. should be used for longer term storage. The product will firm up to a semi-solid on storage and may be subsequently demoulded and sliced or shredded as required.

One of the principal benefits of the process of the invention is that the cheese maker using either process does not generate any whey during manufacture. The benefits of this are tremendous since traditional cheese plants must process about 19 parts of highly perishable milk and whey for every 1 part of cheese produced at considerable capital, operational and often environmental expense. The process of the current invention provides for the processing of about 0.5 parts of shelf stable dry ingredients (although perishable ingredients like liquid NCI and cream are not excluded) together with 0.5 parts of water (the water may be provided partly or completely by liquid cream or liquid NCI if they are used) to produce 1 part of cheese with unique nutritional properties. The capital savings this process offers are enormous and conservatively estimated to be a ten-fold reduction on a traditional plant with the same production capacity. Other benefits are that the stability of the ingredients and simplicity of the conversion process allows for this cheese to be manufactured in regions where there is no native milk supply. In addition the conversion or cheese making process could easily be performed in store or restaurant. The make time of minutes is significantly less than the hours required for conventional methods.

### EXAMPLE 1

Manufacture of the NCI

Microfiltration/Ultrafiltration

For the microfiltration steps, a Crossflow Microfiltration system (MFS-7, Tetra Pak Filtration, Aarhus, Denmark) is used. The unit consisted of 7 ceramic membrane elements, each having a surface area of 0.2 m², giving a total membrane area of 1.4 m². The membranes used (Societe des Ceramiques Technique-Membralox, Bazet, France) have an average pore diameter of 0.1μ, a channel diameter of 4 mm and are aluminium based ceramic membranes. This plant is operated in a continuous mode.

For the ultrafiltration step, a batch concentration ultrafiltration system is used. The unit comprises 2 membranes each having a surface area of 6.4 m², giving a total membrane area of 12.8 m². The membranes used are KOCH type—HFK131. These membranes are spiral wound, polyethersulfone having a nominal molecular weight cut off (MWCO) in the range 5,000-8,000 Dalton.

Operating Conditions

The microfiltration plant operates using the Tetra Pak designed Uniform Transmembrane Pressure (UTMP) control system. This system results in a uniform transmembrane pressure all over the membrane area.

The microfiltration is carried out at 50° C. The pressure at the retentate inlet and outlet is 4.5 bar and 2.6 bar, and at the permeate inlet and outlet it is 3.8 and 2.2 bar.

When operating the plant, the difference between the inlet and outlet Trans Membrane Pressures (TMP) is maintained at a value of 0.3. This difference was calculated as follows:

| | |
|---|---|
| Retentate in (PRi) = | 4.5 bar |
| Permeate in (PPi) = | 3.8 bar |
| TMP inlet = | 0.7 bar |
| Retentate out (PRo) = | 2.6 bar |
| Permeate out (PPo) = | 2.2 bar |
| TMP inlet = | 0.4 bar |
| Difference (TMPi − TMPo) = | 0.3 bar |

The plant is operated at a concentration factor (CF) of 2.5× and a permeate flux of 50 L/m²/h. The concentration factor for MF is calculated as follows:

CF=(retentate flow+permeate flow)/retentate flow

The ultrafiltration plant is operated at an inlet pressure of 4 bar and an outlet pressure of 1.5 bar.

NCI Process Conditions

The process is illustrated in FIG. 1.

Pasteurised skimmed milk was obtained from a production run at Glanbia Ingredients, Ballyragget Factory, Co. Kilkenny. This material was heated to 50° C. and processed through the MF plant at a CF of 2.5× and a permeate flux off 50 L/m²/h. The micellar casein is retained during MF and is further washed using diafiltration.

The diafiltration was carried out in a batch mode by diluting the MF retentate to 8% TS with the diafiltration water and passing it through the MF plant again. The MF was again operated at 50° C., CF of 2.5× and a permeate flux off 50 L/m²/h.

The MF retentate from the DF step was diluted to 10% total solids. This material was HTST pasteurised at 72° C.×16 sec. Ultrafiltration and diafiltration of this material was then carried out at 50° C.

The UF retentate (NCI) was dried at 50° C. and 20-25% TS. A spray dryer (APV Anhydro, Copenhagen, Denmark) with nozzle atomisation was used. The inlet and outlet air temperatures were 200° C. and 98° C., respectively.

It will be appreciated that this example of NCI manufacture is not intended to be proscriptive. Indeed alternative operating parameters are attainable, for example higher flow rates and CF factors are attainable. Also an evaporation step may be employed prior to or in-place of the spray-drying step. Indeed the MF/UF retentate may be utilised if a sufficiently high protein is attained. Furthermore, as is known to those skilled in the art lower pH during UF and MF facilitates the removal of some of the calcium.

### EXAMPLE 2

Using Natural Cheese Method

The following formulation is made up using the procedure indicated below

| | Ingredient Composition | | | | |
|---|---|---|---|---|---|
| INGREDIENTS | % T.S. | % Lac. | % Pro. | % FAT | % (wt/wt) |
| NCI from example 1 | 96.26 | 0.1 | 86.97 | 1.59 | 25 |
| Cream | 49 | 3 | 2.2 | 42 | 51 |
| Salt NaCl | 100 | 0.09 | | | 1.5 |
| Hot tap Water 1 | 0 | | | | 20 |
| (50° C.) + Steam | | | | | |
| Lactic acid (10% w/v) | 10 | | | | 1 |
| Rennet enzyme | 0 | | | | 1.5 |
| Chymax Ultra | | | | | |
| (1:40 dilution) | | | | | |
| Culture DVS | | | | | Q.S. |
| TOTAL | | | | | 100 |

| | Method |
|---|---|
| 1 | Mix the hot tap water with the cream and heat to 50° C. |
| 2 | Slowly mix in the NCI and salt. Homogenise gently for 1 min. Add |
| | thermophilic culture if desired |
| 3 | Add the rennet and mix slowly for 5 minutes |
| 4 | Pasteurise to 72° C. × 30 sec |
| 5 | Add acid to hot mix, adjusting to pH 5.7 and stirr for 1 minute |
| 6 | Pack and cool to 4 to 6° C. |

Since no whey is drawn off the composition of the finished product is:

| | |
|---|---|
| Moisture | 49.70% |
| Lactose | 2.3% |
| CMP | 0.6% |
| CMP: Whey Protein | 1:1.9 |
| Protein | 22.86% |
| FAT | 21.80% |
| Peak Force | 2641 g |

The balance being made up of primarily minerals and organic salts.

### EXAMPLE 3

Using Process Cheese Method

| | Ingredient Composition | | | | |
|---|---|---|---|---|---|
| INGREDIENTS | % T.S. | % Lac. | % Pro. | % FAT | % (wt/wt) |
| NCI from example 1 | 95.25 | 1.85 | 82.75 | 2.04 | 27 |
| Cream | 49 | 3 | 2.2 | 42 | 51 |
| Salt NaCl | 100 | 0.09 | | | 2 |
| Hot tap Water 1 | | | | | 8.9 |
| (50 oC.?) | | | | | |
| Disodium Phosphate | 100 | | | | 1 |
| Anhydrous | | | | | |
| GDL (15% solution) | | | | | 10 |
| Rennet enzyme | | | | | 0.1 |
| Chymax Ultra | | | | | |
| Culture DVS | | | | | Q.S. |
| TOTAL | | | | | 100 |

| | Method |
|---|---|
| 1 | Mix the hot tap water with the cream and heat to 50° C. Add GDL |
| 2 | Slowly mix in the NCI and salt. Homogenise gently for 1 min. |
| 3 | Add 1 ml of Hannilase Rennet per Kg of Cheese at 40° C. Allow to |
| | clot for 30 min. |
| 4 | Add Disodium Phosphate while mixing. |
| 5 | Heat to 72° C. for 30 sec. |
| 6 | Pack and cool to 4-6° C. |

As with example 1 no whey is required to be removed and the composition of the finished product is:

| | |
|---|---|
| Moisture | 48.29% |
| Lactose | 2.32% |
| CMP | 0.74% |
| CMP: Whey Protein | 1:1.6 |
| Protein | 23.46% |
| FAT | 21.97% |

The balance being made up of primarily minerals and organic salts.

The invention is not limited to the embodiments herein described and may be varied in detail. For example oils of plant, marine or other origins may be used in place of the cream described herein. Other ingredients with physical or biological functionality may be added to further enhance the finished product to the tastes of the local market. Indeed since no whey need be removed, this technology is ideally suited to these modifications since the added ingredients will remain with the product and not tend to be largely lost in the whey.

1. A dairy product containing dairy proteins, the product being at least semi-solid and containing greater than 0.15% by weight of casein macropeptide (CMP) and a mass ratio of CMP to whey protein being greater than 1:4.9.

2. An at least semi-solid dairy product containing greater than 0.15 % by weight of casein macropeptide (CMP), the product having less than 2.5% of whey protein.

3. A method for manufacturing an at least semi-solid dairy product which comprises:
(i) combining with the aid of mixing and heating as necessary:
a) an amount of natural casein isolate (NCI) protein source such that 7% to 85% of the product by weight is NCI protein;
b) an amount of a moisture source such that 10% to 85% of the product by weight is moisture;
c) an amount of a fat source such that 0.1% to 60% of the product by weight is fat; and subjecting the mixture thus formed to the action of a coagulant such as rennet enzyme sufficient to convert the mixture to an at least semi-solid product at room temperature or below and/or to hydrolyse at least 50% of the kappa casein between amino acid residue 105 and 106 present in the mixture.
